(19) United States
(12) Patent Application Publication
(10) Pub. No.: US 2025/0076459 A1
(43) Pub. Date: Mar. 6, 2025

(54) METHOD FOR RADAR SENSOR DATA PROCESSING, AND RADAR SENSOR DATA PROCESSING SYSTEM

(71) Applicant: Robert Bosch GmbH, Stuttgart (DE)

(72) Inventors: Tobias Schmid, Fluorn-Winzeln (DE); Daniel Schindler, Korntal-Münchingen (DE); Fabian Roos, Goeppingen (DE)

(21) Appl. No.: 18/783,832

(22) Filed: Jul. 25, 2024

(30) Foreign Application Priority Data
Aug. 30, 2023 (DE) 10 2023 208 296.9

(51) Int. Cl. G01S 7/35; G01S 13/04; G01S 13/931

(52) U.S. Cl. CPC G01S 7/354; G01S 7/356; G01S 13/04; G01S 13/931

(57) ABSTRACT

A method for radar sensor data processing of radar sensor data of a radar sensor system detecting at least one target object in an environment of a carrier system. A radar sensor data processing system is also described.

### CROSS REFERENCE

The present application claims the benefit under 35 U.S.C. § 119 of German Patent Application No. DE 10 2023 208 296.9 filed on Aug. 30, 2023, which is expressly incorporated herein by reference in its entirety.

### FIELD

The present invention relates to a method for radar sensor data processing. The present invention also relates to a radar sensor data processing system.

### BACKGROUND INFORMATION

Driving assistance systems in vehicles use radar sensors to detect a vehicle environment of the vehicle and to detect target objects in the vehicle environment. When detecting the surroundings with radar sensors, a high angular resolution is desired, which in turn depends on the size of the antenna aperture. In the case of radar sensors composed of a plurality of transmit/receive units, the entire sensor array forms a virtual antenna aperture that goes beyond the physical aperture. Such radar systems may, for example, be constructed as a MIMO radar sensor comprising the plurality of transmit/receive units. In order to increase the total antenna aperture, the transmit/receive units are arranged at larger and irregular distances to one another.

In such sparse arrangements, the transmit/receive units are not distributed evenly. This can produce side lobes that interfere with the exact determination of the direction of arrival (DoA) of a received radar reflection of a target object.

In order to detect and eliminate the side lobes, the method described in “A Unified Approach to Sparse Signal Processing,” F. Marvasti, A. Amini, F. Haddadi, M. Soltanolkotabi, B. H. Khalaj, A. Aldroubi, S. Sanei and J. Chambers, EURASIP Journal on Advances in Signal Processing, vol. 2012, No. 1, p. 44, February 2012, is, for example, used to convert the phase signals of the sensor array through a Fourier transform into an angular spectrum, to subsequently exclude the side lobes that are present in the angular spectrum and are close to the actual signal values but have lower amplitudes, through a signal value threshold defined directly depending on the amplitude of the largest lobe, in order to obtain a processed phase signal from this processed angular spectrum through an inverse Fourier transform of the angular components that exceed the defined signal value threshold. This reworking process is iteratively repeated in that the undesired side lobes in the angular spectrum are reduced in each pass, making it possible to tune the defined signal value threshold more precisely. These iterations are continued until a radar signal or angular spectrum as adjusted as possible for the side lobes has been calculated.

In addition to the IMAT algorithm, further methods for eliminating the influences of the side lobes are available. For example, the CLEAN algorithm looks for the highest lobe in the angular spectrum, transforms this value back into the spatial phase signal, removes the corresponding components in the spatial phase signal at the existing locations, and thus generates a phase signal for a second detection, which phase signal now no longer contains the initially detected target.

Another iterative algorithm is RELAX for solving non-linear optimization problems. In this case, a signal that matches both the measured data and a defined model concept is sought by using a penalty function in order to favor solutions that have a low number of non-zero elements (sparsity).

### SUMMARY

According to the present invention, a method for radar sensor data processing is provided. The computational effort and time can thereby be reduced. The signal data processing can be performed more efficiently, faster, and more simply.

The carrier system may be movable, in particular drivable. The carrier system may be a vehicle, in particular a motor vehicle, two-wheeled vehicle or truck. The vehicle may be a mobile robot.

The target object may be a creature, a device, an object, a vehicle, a building, a plant, and/or a roadway property.

The receive unit may be an individual radar sensor and/or a receive channel of a radar sensor. The receive unit may be a physical or virtual receive channel.

The radar sensor system may be constructed as a spatial network of a plurality of radar sensors, in which network the radar sensors form the receive units. By moving a radar sensor, the radar sensor system may comprise a plurality of temporally distributed receive units formed by the individual radar sensor at different times. The radar sensor system may comprise a radar sensor comprising a plurality of receive channels and at least one, in particular a plurality of, transmit channels. The receive channels may form the receive units. The radar sensor may be a MIMO radar sensor.

The sparse distribution of the receive units means that there is at least one missing element in the otherwise even, regular, uniform, harmonic and/or ordered receive unit distribution. The sparse distribution may also extend to the plurality of transmit channels. Besides the at least one missing element, the receive unit distribution may also be disordered, irregular, uneven, and/or non-uniform.

The phase signal can specify the phase shift depending on the spatial and/or temporal position of the receive unit in the receive unit distribution of the radar sensor system.

The main lobe may have a greater or lesser amplitude in comparison to a side lobe. All side lobes are indirectly or directly caused by the missing element or the missing elements. All main lobes are indirectly or directly assigned to the object target or respective object targets.

According to an example embodiment of the present invention, in addition to the selection criterion, a further selection criterion for selecting the angular spectrum component may be provided.

According to an example embodiment of the present invention, the selection criterion or the further selection criterion may be a defined signal value threshold. The signal value threshold can be defined to decrease with increasing iteration steps. The lobes in the angular spectrum whose amplitudes reach or exceed the signal value threshold can be included in the angular spectrum component. The signal components in the angular spectrum whose amplitude falls below the signal value threshold can be excluded from the angular spectrum component. The selected angular spectrum component can be limited to only the lobes that have amplitudes in the angular spectrum that are above the signal value threshold.

According to an example embodiment of the present invention, the further selection criterion may be applied in at least one iteration step in addition to the selection criterion. The further selection criterion may be applied in at least one iteration step without the selection criterion. However, the selection criterion is applied in at least one iteration step.

The further selection criterion may be a signal value threshold which directly depends on the amplitude of the largest lobe in the angular spectrum.

In a fast Fourier transform (FFT)-based angle estimation, for example the conventional IMAT method, the back transform is typically performed as an inverse fast Fourier transform (iFFT) over the full angular spectrum. In the case of the first iteration with the first iteration step, the changed angular spectrum, which is to be transformed back and is limited to the selected angular spectrum component, can consist of only one bin, in all further iteration steps, of few bins, that actually contain spectral information, while all further bins, which are not above a specified signal value threshold, are set to zero. The back transform can in this case be implemented as a limited back transform not comprising the entire angular spectrum, for example as an inverse discrete Fourier transform (iDFT), in particular as follows

$$x ( {t}_{n} ) = X ( {ω}_{max , n} ) \cdot {e}^{j \cdot {ω}_{max , n} \cdot {t}_{n}}$$

with the time signal x(tₙ) of the nth receive unit, the Fourier transform X(ω_{max,n}) and the angle ω_{max,n} of the lobe to be transformed.

In a preferred embodiment of the present invention, it is advantageous if the selection criterion comprises an amplitude change behavior of at least one of the lobes in the angular spectrum over at least one iteration step. The selection criterion may be the amplitude change behavior. The selection criterion may include the amplitude change behavior of a plurality of amplitude changes.

In a particular example embodiment of the present invention, it is advantageous if an amplitude change reducing the amplitude of one of the lobes is used for labeling as a side lobe. As a result, lobes can be excluded depending on the amplitude change.

In a preferred example embodiment of the present invention, it is advantageous if an amplitude change increasing the amplitude of a lobe, or no amplitude change, i.e., a constant amplitude, is used for labeling as a main lobe. As a result, lobes can be included depending on the amplitude change. The exclusion of the lobes as side lobes and the inclusion of the lobes as main lobes can be used separately or in combination.

In an advantageous example embodiment of the present invention, it is provided that the selection criterion depends on a previously known maximum possible amplitude of any possible side lobes of the radar sensor system. The selection criterion may be a specified signal value threshold depending on the previously known maximum possible amplitude. The previously known amplitude may be calculated by means of previous measurements and/or simulations with the radar sensor system.

By introducing prior knowledge about the sensor array, for example by knowing the maximum possible amplitude of the highest side lobe superimposed for design-related reasons, in particular in the case of two targets with identical amplitude in the angular spectrum, the selection criterion can be selected such that significantly more spectral angular bins are included. For example, the signal value threshold dependent on the previously known amplitude may correspond to the previously known amplitude, preferably including a safety distance. As a result, more information can already be used for the back transform in the first iteration step. This introduced prior knowledge makes it possible that only information from true targets and no angular information from side lobes that are possibly superimposed for design-related reasons is used in such a procedure.

In a particular embodiment of the present invention, it is advantageous if the selection criterion is a selection angle range that depends on an individual angle range specified by at least one individual receive unit and delimited from the total angle range covered by the radar sensor system as a whole. The selection angle range may comprise the individual angle range or may correspond to the individual angle range. The individual angle range may be the maximum angle range coverable by an individual receive unit. The receive units of the radar sensor system may all have the same maximum coverable angle range and/or a different maximum coverable angle range.

The individual angle range may be specified by a number of receive units, wherein the number of receive units is less than the total number of receive units of the radar sensor system.

The individual angle range may be formed as the sum of the respective individual angle ranges of the receive units considered in the number of receive units.

In an advantageous embodiment of the present invention, it is provided that the selection angle range is specified as dependent on the individual angle range if the at least one target object is detected in the individual angle range. The selection criterion may be the selection angle range, in particular only if the at least one target object is detected in the individual angle range.

In order to resolve the number of target objects in the individual angle range, the individual signals of a plurality of receive units can be processed. In the case of matching lobes of a plurality of receive units, an angular environment range including the respective common lobe, in particular at most over the span of the individual angle range of a receive unit, can be defined and isolated. This isolation can take place by specifying a signal value threshold below the amplitude of the lobe. This isolated angular spectrum can be converted by back transform, in particular by iFFT, into a changed phase signal, and the changed phase signal can subsequently be superimposed on the measured phase signal of the further, in particular all virtual, receive units of the radar sensor system. In so doing, the changed phase signal can pre-initialize the respective measured phase signal of the complete set or subset of all receive units on the basis of the at least one receive unit. Preferably, the changed phase signal is normalized and/or weakened before the superimposition with the measured phase signal, in particular in order to change the measured phase information of the further receive units not at all or as little as possible. The measured phase signal may be predominant, in particular free of the superimposition, in the actual measuring receive units. The changed phase signal may be superimposed on the measured phase signal only at the virtual positions of the receive unit distribution.

Advantageous is a preferred embodiment of the present invention in which the individual angle range plus at least a unilateral tolerance angle forms the selection angle range. The unilateral tolerance angle can expand the individual angle range in one direction. The tolerance angle may be added on both sides, i.e., may expand the individual angle range in both directions.

For example, the individual angle range may be 7° and the bilateral tolerance angle may be 3.5°.

Advantageous is a preferred embodiment of the present invention in which a plurality of first receive units is classified into a first receive unit group and a plurality of second receive units is classified into a second receive unit group and a first angular spectrum is created for the first receive unit group and a second angular spectrum is created for the second receive unit group and the selection criterion depends on a spectrum comparison of the first and second angular spectra. The first receive unit group may comprise at least one first receive unit that is not a second receive unit. The first receive unit group may comprise a first receive unit that is a second receive unit.

The second receive unit group may comprise at least one second receive unit that is not a first receive unit. The second receive unit group may comprise a second receive unit that is a first receive unit.

At least one further receive unit group, for which a further angular spectrum is created, may also be formed from the receive units. The selection criterion may depend on a spectrum comparison of the first, second and further angular spectra.

In a particular embodiment of the present invention, it is advantageous if the selection criterion is a match identification with which the lobes that are present in the first and second angular spectra and match with respect to the angle of incidence are identified in the spectrum comparison. The match identification may depend on the amplitude, the angle, the shape of the lobe, and/or the area enclosed by the lobe.

The method for radar sensor data processing may be a computer-implemented method for execution on a processing unit. The processing unit may comprise a processor for at least partially performing the method.

According to the present invention, a radar sensor data processing system for processing radar sensor data is also proposed, comprising a radar sensor system, which provides radar sensor data comprising at least one target object in an environment of a carrier system, and a processing unit, which is configured to process the radar sensor data by means of a method for radar sensor data processing with at least one of the previously described features.

Further advantages and advantageous example embodiments of the present invention emerge from the description of the figures and the figures.

### BRIEF DESCRIPTION OF THE DRAWINGS

The present invention is described in detail below with reference to the figures.

FIG. 1 shows a method for radar sensor data processing in a particular example embodiment of the present invention.

FIG. 2 shows an angular spectrum when using the method for radar sensor data processing in a particular example embodiment of the present invention.

FIG. 3 shows a phase signal when using a method for radar sensor data processing in a particular example embodiment of the present invention.

FIG. 4 shows an angular spectrum for the phase signal of FIG. 3.

FIG. 5 shows an angular spectrum when using a method for radar sensor data processing in a further particular example embodiment of the present invention.

FIG. 6 shows an angular spectrum when using a method for radar sensor data processing in a further particular example embodiment of the present invention.

FIG. 7 shows a target object resolution when using a method for radar sensor data processing in a further particular example embodiment of the present invention.

FIG. 8 shows a spectrum comparison when using a method for radar sensor data processing in a further particular example embodiment of the present invention.

### DETAILED DESCRIPTION OF EXAMPLE EMBODIMENTS

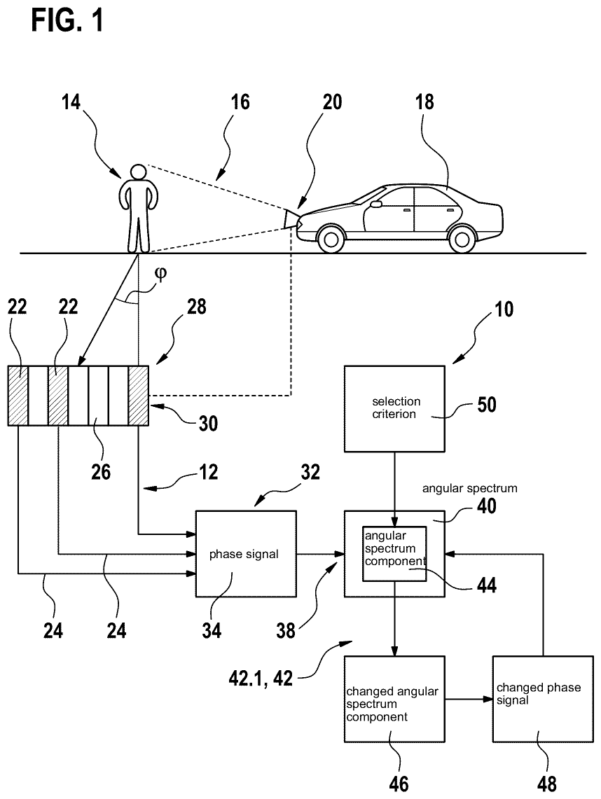

FIG. 1 shows a method for radar sensor data processing in a particular embodiment of the present invention. The method for radar sensor data processing 10 processes radar sensor data 12 of a radar sensor system 20 detecting at least one target object 14 in an environment 16 of a carrier system 18, here a vehicle. The radar sensor system 20 comprises a plurality of temporally and/or spatially distributed receive units 22, each for receiving the radar signals, reflected by the target object 14, as an individual signal 24. The distribution of the receive units 22 in the radar sensor system 20 is sparse with at least one missing element 26 in the receive unit distribution 28.

First, the radar sensor system 20 is provided 30. Subsequently, a phase signal 34 is provided 32, which is formed from phase shifts of the individual signals 24 that depend on an angle of incidence φ of the radar signals, reflected by the target object 14, with respect to the radar sensor system 20.

With a subsequent conversion 38, the phase signal 34 is converted into an angular spectrum 40, which comprises at least one main lobe at the angle of incidence φ of the individual signal 24 that arrives the most strongly from the target object 14, and at least one side lobe caused by the missing element 26.

In a first iteration step 42.1, signal data processing takes place at least by isolating the at least one main lobe in that the angular spectrum 40 is converted into a changed angular spectrum 46 by selecting an angular spectrum component 44, the changed angular spectrum 46 is converted into a changed phase signal 48, and the changed phase signal 48 is again converted into an angular spectrum 40.

In subsequent iteration steps 42, the sequence of the first iteration step 42.1 repeats. In at least one of the iteration steps 42, the angular spectrum component 44 is selected depending on at least one selection criterion 50 which is independent of or at most indirectly depends on the amplitude of the largest lobe in the angular spectrum. As a result, the signal data processing can be carried out more efficiently, faster, and more simply.

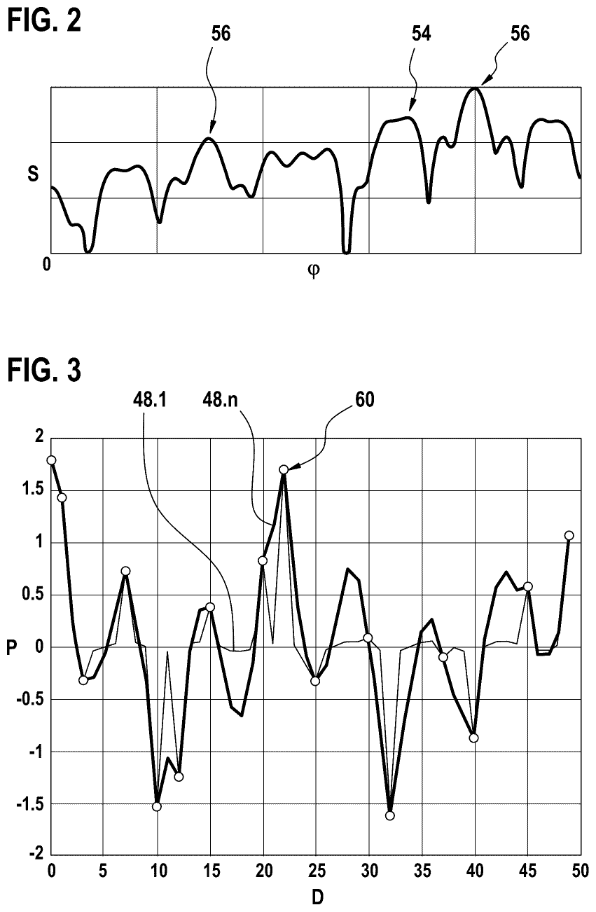

FIG. 2 shows an angular spectrum when using the method for radar sensor data processing. The angular spectrum 40 shows the signal value S depending on the angle of incidence φ of the radar signals. The cause of side lobes 54 in the angular spectrum 40 are the missing elements in the sparse receive unit distribution in the radar sensor system. In the angular spectrum 40, these missing elements manifest as design-related superimpositions in the side lobes 54, whereby the two main lobes 56 assigned to a respective target object have a lower amplitude than the side lobes 54. This results in a reduction of the dynamic range in the angular spectrum 40.

FIG. 3 shows a phase signal when using a method for radar sensor data processing in a particular embodiment of the present invention. The phase signal P depends on the position D with respect to the antenna array of the radar sensor system. Shown here are a measured phase signal 60 represented as points at the locations D(n) of the virtual antenna array, a first changed phase signal 48.1 after a first iteration step, and a further changed phase signal 48.n after at least one further iteration step.

In the first changed phase signal 48.1 and in the further changed phase signal 48.n, the measured phase signal 60 is filled up with approximation values, which replace the influences of the missing elements as faithfully as possible.

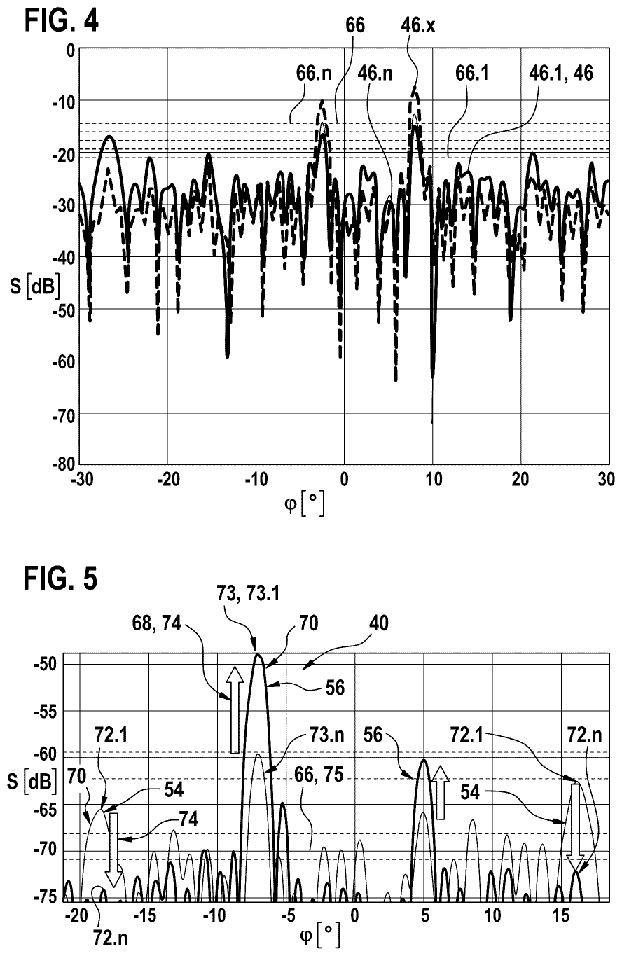

FIG. 4 shows an angular spectrum for the phase signal of FIG. 3. In the angular spectrum 40, which specifies the signal value S depending on the angle of incidence p, a signal value threshold 66 is defined as the selection criterion in each iteration step. In a first iteration step, a first signal value threshold 66.1 is applied to the then present first changed angular spectrum 46.1 and, in a further iteration step, a reduced further signal value threshold 66.n is applied to the then present further angular spectrum 46.n, as a result of which the final changed angle signal 46.x is present after the back transform via the changed phase signal.

In each iteration step, the spectral signal values S above the respective signal value threshold 66 are transformed back into the changed phase signal and the previously non-present values therein are replaced, and the missing locations in the phase signal are thus occupied with a complex estimated value generated based on the considered spectral information, as shown in FIG. 3. The thus completed changed phase signal can be used in further iteration steps as the basis for the changed angular spectrum 46, to which in turn a reduced signal value threshold 66 is then applied iteratively as the selection criterion.

FIG. 5 shows an angular spectrum when using a method for radar sensor data processing in a further particular embodiment of the present invention. By observing the amplitude change behavior 68 of the lobes 70 in the angular spectrum 40 and thus the gradient of the amplitudes 72 of the lobes 70 over the iteration steps, the selection criterion can comprise an amplitude change behavior 68 of the amplitudes 72 of the lobes 70 that change over the iteration steps, the lobes in this example including main lobes 56 and side lobes 54. Through the iteration steps, the amplitude 72 of the side lobes 54 becomes smaller starting from a respective first amplitude 72.1 up to respective further amplitudes 72.n, and the amplitude 73 of the main lobes 56 becomes larger or is constant starting from respective first amplitudes 73.1 up to respective further amplitudes 73.n. An amplitude change 74 reducing the respective amplitude 72, 73 of the lobe 70 can be used for labeling as a side lobe 54, and an amplitude change 74 increasing the respective amplitude 72, 73 of the lobe 70 can be used for labeling as a main lobe 56.

If a signal value threshold 66 decreasing with increasing iteration steps is applied as a further selection criterion 75, the main lobes 56 can already be included in the angular spectrum component by the selection criterion of the amplitude change behavior 68, even if the amplitude 73 of the main lobe 56 is still smaller than the signal value threshold 66 applied in the respective iteration step. Conversely, the side lobes 54 can already be excluded from the angular spectrum component by the selection criterion of the amplitude change behavior 68, even if the amplitude 72 of the side lobe 54 is still greater than the signal value threshold 66 applied in the respective iteration step. The information about the amplitude change behavior 68 can also be used to detect or to make plausible and evaluate the number of target objects in the angular spectrum 40. Alternatively, the application of the further selection criterion 75 with the signal value threshold 66 may be dispensed with. Alternatively, after reliably identifying main lobes and side lobes after n iterations, further iterations could also be completely dispensed with, as a termination criterion, and/or the signal value thresholds could be limited only in the selected ranges, for example to the left and right of the identified main lobes, for further suppression of the noise level before the detection and, in the process, further observation of the lobes.

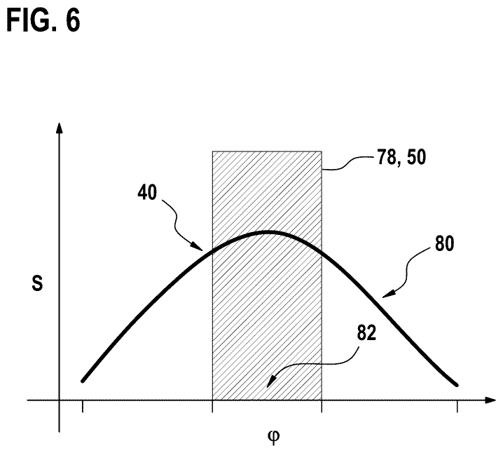

FIG. 6 shows an angular spectrum when using a method for radar sensor data processing in a further particular embodiment of the present invention. The angular spectrum 40 is depicted with a selection angle range 78 representing the selection criterion 50. The selection angle range 78 depends on an individual angle range 82 defined by at least one individual receive unit and delimited from the total angle range 80 covered by the radar sensor system as a whole. The selection angle range 78 is specified as dependent on the individual angle range 82, in particular as corresponding to the individual angle range 82, if the at least one target object is detected in the individual angle range 82.

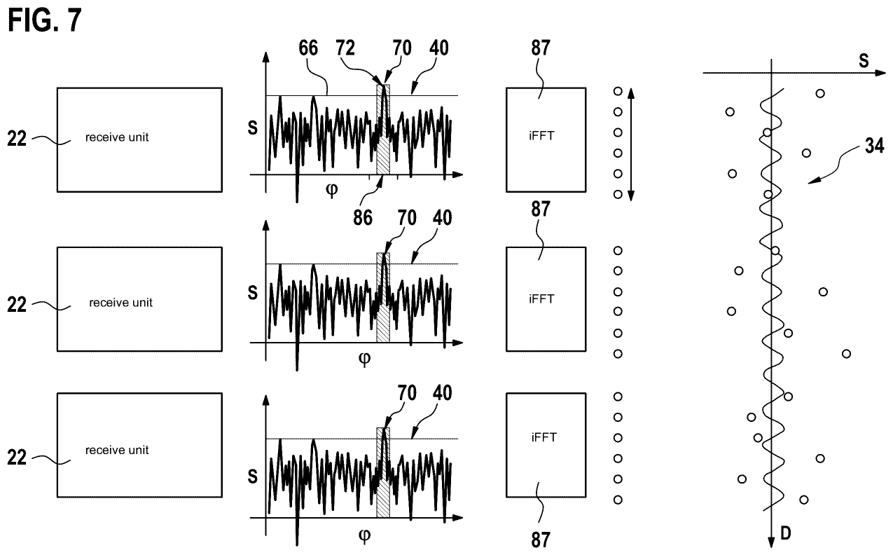

FIG. 7 shows a target object resolution when using a method for radar sensor data processing in a further particular embodiment of the present invention. In order to resolve the number of target objects in the individual angle range, the individual signals of a plurality of receive units 22 can be processed. In the case of matching lobes 70 in the angular spectrum 40 of the plurality of receive units 22, an angular environment range 86 including the respective common lobe 70 can be defined, in particular at most over the span of the individual angle range of a receive unit 22, and isolated. This isolation can take place by specifying a signal value threshold 66 below the amplitude 72 of the lobe 70. This isolated angular spectrum can be converted by back transform, in particular by iFFT 87, into a changed phase signal 34, and the changed phase signal 34 can subsequently be superimposed on the measured phase signal of the further, in particular all, receive units 22 of the radar sensor system. In so doing, the changed phase signal 34 can pre-initialize the respective measured phase signal of the receive units 22. Preferably, the changed phase signal 34 is normalized and/or weakened before the superimposition with the measured phase signal, in particular in order to change the measured phase information of the further receive units 22 not at all or as little as possible. In so doing, the superimposition can be limited to the unoccupied spatial positions of the virtual sensor array of the radar sensor system. The measured phase information at previously occupied spatial, virtual positions of the sensor array is not changed.

Superimposing or averaging in particular means that the various individual sensors of the sensor array may provide somewhat different phase signals. These signals can be superimposed or averaged. Since the individual sensors have much fewer virtual antenna positions than the total aperture, the signal course must be extrapolated from the individual sensors to the entire arrangement.

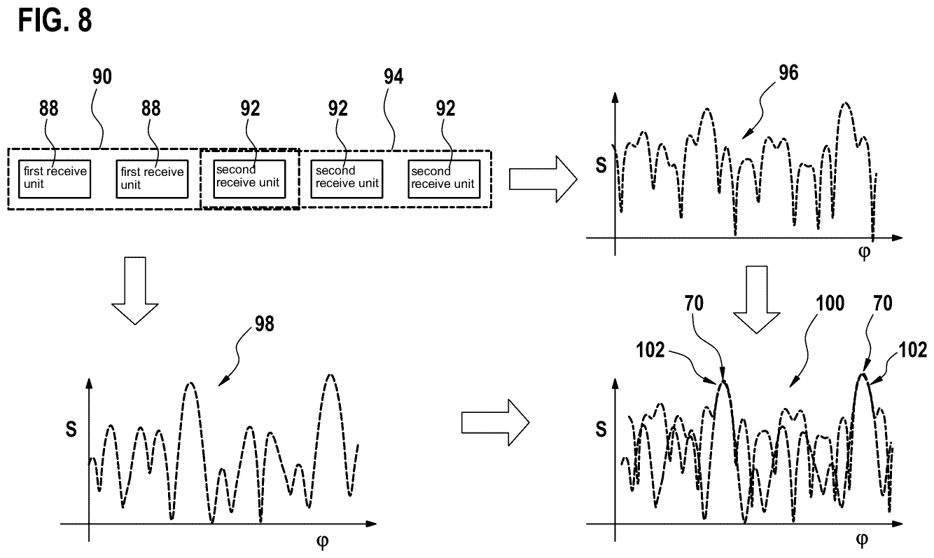

FIG. 8 shows a spectrum comparison when using a method for radar sensor data processing in a further particular embodiment of the present invention. First, a plurality of first receive units 88 is classified into a first receive unit group 90 and a plurality of second receive units 92 is classified into a second receive unit group 94, wherein a first angular spectrum 96 is created for the first receive unit group 90 and a second angular spectrum 98 is created for the second receive unit group 94 and the selection criterion depends on a spectrum comparison 100 of the first and second angular spectra 96, 98. The selection criterion is in each case a match identification 102, with which the lobes 70 that are present in the first and second angular spectra 96, 98 and match with respect to the angle of incidence φ are identified in the spectrum comparison 100.

What is claimed is:

1. A method for radar sensor data processing of radar sensor data of a radar sensor system detecting at least one target object in an environment of a carrier system, the method comprising the following steps:
providing the radar sensor system including a plurality of temporally and/or spatially distributed receive units, each configured to receive radar signals, reflected by the target object, as individual signals, wherein the distribution of the receive units is sparse with at least one missing element in the receive unit distribution;
providing a phase signal formed from phase shifts of the individual signals that depend on an angle of incidence of the radar signals, reflected by the target object, with respect to the radar sensor system;
converting the phase shifts, included in the phase signal, into an angular spectrum including lobes, the angular spectrum including at least one main lobe assigned to the target object and at least one side lobe caused by the missing element; and
iterative signal data processing over a plurality of iteration steps, at least by isolating the at least one main lobe in that the angular spectrum is converted into a changed angular spectrum by selecting an angular spectrum component, the changed angular spectrum is converted into a changed phase signal, and the changed phase signal is again converted into an angular spectrum;
wherein, at least in one of the iteration steps, the angular spectrum component is selected depending on at least one selection criterion which is independent of or at most indirectly depends on an amplitude of the largest lobe in the angular spectrum.

2. The method for radar sensor data processing according to claim 1, wherein the selection criterion includes an amplitude change behavior of at least one of the lobes in the angular spectrum over at least one of the iteration steps.

3. The method for radar sensor data processing according to claim 2, wherein an amplitude change reducing an amplitude of one of the lobes is used for labeling as a side lobe.

4. The method for radar sensor data processing according to claim 2, wherein an amplitude change increasing an amplitude of one of the lobes, or no amplitude change, is used for labeling as the main lobe.

5. The method for radar sensor data processing according to claim 1, wherein the selection criterion depends on a previously known maximum possible amplitude of any possible side lobes of the radar sensor system.

6. The method for radar sensor data processing according to claim 1, wherein the selection criterion is a selection angle range that depends on an individual angle range specified by at least one individual receive unit and delimited from a total angle range covered by the radar sensor system as a whole.

7. The method for radar sensor data processing according to claim 6, wherein the selection angle range is specified as dependent on the individual angle range when the at least one target object is detected in the individual angle range.

8. The method for radar sensor data processing according to claim 6, wherein the individual angle range plus at least a unilateral tolerance angle forms the selection angle range.

9. The method for radar sensor data processing according to claim 1, wherein a plurality of first receive units is classified into a first receive unit group and a plurality of second receive units is classified into a second receive unit group and a first angular spectrum is created for the first receive unit group and a second angular spectrum is created for the second receive unit group and the selection criterion depends on a spectrum comparison of the first and second angular spectra.

10. The method for radar sensor data processing according to claim 9, wherein the selection criterion is a match identification with which lobes that are present in the first and second angular spectra and match with respect to an angle of incidence are identified in the spectrum comparison.

11. A radar sensor data processing system for processing radar sensor data, comprising:
a radar sensor system providing radar sensor data including at least one target object in an environment of a carrier system, the radar sensor system including a plurality of temporally and/or spatially distributed receive units, each configured to receive radar signals, reflected by the target object, as individual signals, wherein the distribution of the receive units is sparse with at least one missing element in the receive unit distribution; and
a processing unit configured to process the radar sensor data by:
providing a phase signal formed from phase shifts of the individual signals that depend on an angle of incidence of the radar signals, reflected by the target object, with respect to the radar sensor system;
converting the phase shifts, included in the phase signal, into an angular spectrum including lobes, the angular spectrum including at least one main lobe assigned to the target object and at least one side lobe caused by the missing element; and
iterative signal data processing over a plurality of iteration steps, at least by isolating the at least one main lobe in that the angular spectrum is converted into a changed angular spectrum by selecting an angular spectrum component, the changed angular spectrum is converted into a changed phase signal, and the changed phase signal is again converted into an angular spectrum;
wherein, at least in one of the iteration steps, the angular spectrum component is selected depending on at least one selection criterion which is independent of or at most indirectly depends on an amplitude of the largest lobe in the angular spectrum.
